(19) United States
(12) Patent Application Publication
(10) Pub. No.: US 2013/0114667 A1
(43) Pub. Date: May 9, 2013

(54) BINARISATION OF LAST POSITION FOR HIGHER THROUGHPUT

(71) Applicant: SONY CORPORATION, Tokyo (JP)

(72) Inventor: Cheung Auyeung, Sunnyvale, CA (US)

(73) Assignee: SONY CORPORATION, Tokyo (JP)

(21) Appl. No.: 13/654,150

(22) Filed: Oct. 17, 2012

Related U.S. Application Data
(60) Provisional application No. 61/557,225, filed on Nov. 8, 2011.

(51) Int. Cl. H04N 7/26

(52) U.S. Cl. 375/240.01; 375/E07.026

(57) ABSTRACT

For encoding the last position (x, y) of the transform coefficients in a given scan order with Context-Adaptive Binary Arithmetic Coding (CABAC), to improve throughput, the binarisation is ordered with the unary code of x and y followed by fixed binary codes of x and y.

### CROSS-REFERENCE TO RELATED APPLICATION(S)

This application claims priority under 35 U.S.C. §119(e) of the U.S. Provisional Patent Application Ser. No. 61/557,225, filed Nov. 8, 2011 and titled, “BINARISATION OF LAST POSITION FOR HIGHER THROUGHPUT” which is also hereby incorporated by reference in its entirety for all purposes.

### FIELD OF THE INVENTION

The present invention relates to the field of image processing. More specifically, the present invention relates to high efficiency video coding.

### BACKGROUND OF THE INVENTION

High Efficiency Video Coding (HEVC), also known as H.265 and MPEG-H Part 2, is a draft video compression standard, a successor to H.264/MPEG-4 AVC (Advanced Video Coding), currently under joint development by the ISO/IEC Moving Picture Experts Group (MPEG) and ITU-T Video Coding Experts Group (VCEG). MPEG and VCEG have established a Joint Collaborative Team on Video Coding (JCT-VC) to develop the HEVC standard. HEVC improves video quality and double the data compression ratio compared to H.264, and scales from 320×240 to 7680×4320 pixels resolution.

### SUMMARY OF THE INVENTION

For encoding the coordinate (x, y) of the last non-zero transform coefficient in a given scan order with Context-Adaptive Binary Arithmetic Coding (CABAC), to improve throughput, the binarisation is ordered with the unary code of x and y followed by fixed binary codes of x and y.

In one aspect, a method of implementing a context-adaptive binary arithmetic coding of a coordinate (x, y) programmed in a device comprises performing binarisation, implementing context-based and bypass binary arithmetic coding, wherein unary bins of x and y are encoded before fixed bins of x and y are encoded and generating output bits from the context-based and bypass binary arithmetic coding. The method further comprises applying renormalization. A truncated unary coding part of a first component is encoded before a truncated unary coding part of a second component. A truncated unary coding part of a second component is encoded before a truncated unary coding part of a first component. A fixed coding part of a first component is encoded before a fixed coding part of a second component. A fixed coding part of a second component is encoded before a fixed coding part of a first component. The fixed bins of x and y are encoded in a bypass mode. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.

In another aspect, an apparatus for encoding a coordinate (x, y) comprises a non-transitory memory for storing an application, the application for performing binarisation, implementing context-based and bypass binary arithmetic coding, wherein unary bins of x and y are encoded before fixed bins of x and y are encoded and generating output bits from the context-based and bypass binary arithmetic coding and a processing component coupled to the memory, the processing component configured for processing the application. The application is further for applying renormalization. A truncated unary coding part of a first component is encoded before a truncated unary coding part of a second component. A truncated unary coding part of a second component is encoded before a truncated unary coding part of a first component. A fixed coding part of a first component is encoded before a fixed coding part of a second component. A fixed coding part of a second component is encoded before a fixed coding part of a first component. The fixed bins of x and y are encoded in a bypass mode. The apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.

In another aspect, an encoder of a coordinate (x, y) comprises a binariser for reducing syntax elements to a reduced binary alphabet, a context-adaptive coder and a bypass coder for performing encoding including arithmetic coding, wherein unary bins of x and y are encoded before fixed bins of x and y are encoded, a renormalizer for rescaling arithmetic coding states from the arithmetic coding and a bit generator for generating bits and appending the bits to an output stream. Atruncated unary coding part of a first component is encoded before a truncated unary coding part of a second component. A truncated unary coding part of a second component is encoded before a truncated unary coding part of a first component. A fixed coding part of a first component is encoded before a fixed coding part of a second component. A fixed coding part of a second component is encoded before a fixed coding part of a first component. The fixed bins of x and y are encoded in a bypass mode.

### BRIEF DESCRIPTION OF THE DRAWINGS

FIG. 1 illustrates a diagram of HM4.0 adopted JCTVC-F357 to binarise the last position coordinates (x,y) of transform coefficients with unary codes and fixed binary codes.

FIG. 2 illustrates a diagram of the unary bins of both x and y encoded first, then the fixed bins of x and y encoded later in bypass mode with CABAC to improve throughput according to some embodiments.

FIG. 3 illustrates a flowchart of a method of CABAC encoding according to some embodiments.

FIG. 4 illustrates a high-level architecture of a CABAC encoder according to some embodiments.

FIG. 5 illustrates a block diagram of an exemplary computing device configured to implement the binarisation of last position method according to some embodiments.

### DETAILED DESCRIPTION OF THE PREFERRED EMBODIMENT

For encoding with Context-Adaptive Binary Arithmetic Coding (CABAC), HM4.0 binarised the x and y coordinates of the last position with unary codes interleaved with fixed binary codes. To improve throughput, the binarisation is reordered with the unary code of x and y, followed by fixed binary codes of x and y.

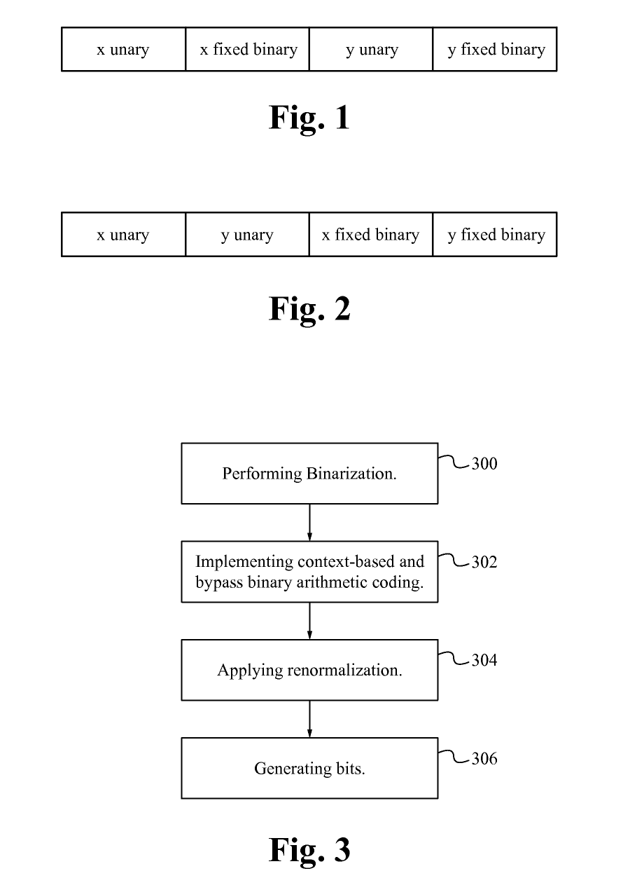

As shown in FIG. 1, HM4.0 adopted JCTVC-F357 to binarise the last position coordinates (x,y) of transform coefficients of a block with unary codes and fixed binary codes. The unary binarisation and the fixed binarisation are interleaved. The fixed bins are encoded in bypass mode with CABAC, and they do not require contexts. FIG. 1 shows the unary binarisation is interleaved with fixed binarisation to encode the last position coordinates (x,y) of transform coefficients by HM4.0 with CABAC. The (x, y) coordinates are encoded by CABAC in the following order:

1) the truncated unary coding part of the first component with CABAC in adaptive mode.

2) the fixed length part of the first component encoded with CABAC in bypass mode.

3) the truncated unary coding part of the second component with CABAC in adaptive mode.

4) the fixed length part of the second component with CABAC in bypass mode.

As shown in FIG. 2, the x and y fixed bins are grouped together to improve throughput since multiple bypass bins are able to be coded in a single cycle for increased throughput. FIG. 2 illustrates the unary bins of both x and y are encoded first, then the fixed bins of x and y are encoded later in bypass mode with CABAC to improve throughput. The (x, y) coordinates are encoded by CABAC in the following order:

1) the truncated unary coding part of the first component with CABAC in adaptive mode.

2) the truncated unary coding part of the second component with CABAC in adaptive mode.

3) the fixed length part of the first component encoded with CABAC in bypass mode.

4) the fixed length part of the second component with CABAC in bypass mode.

There are several implementations of the binarisation of the last position including encoding the truncated unary coding part of the first and second component with CABC before encoding the fixed length part of the first and second component. In one implementation, the truncated unary coding part of the first component is encoded before the truncated unary coding part of the second component. In one implementation, the truncated unary coding part of the second component is encoded before the truncated unary coding part of the first component. In one implementation, the fixed coding part of the first component is encoded before the fixed coding part of the second component. In one implementation, the fixed coding part of the second component is encoded before the fixed coding part of the first component.

The algorithms were integrated into HM4.0. The simulations were performed in three PC clusters:

All intra simulations are performed on AMD Opteron Processor 6136 cluster @2.4 GHz.

All RA simulations are performed on Intel Xeon X5690 cluster @3.47 GHz.

All LD simulations are performed on Intel Xeon X5680 cluster ˜3.33 GHz.

TABLE 1
No change in coding efficiency is observed for grouping the
bypass bins together.

| | Y | U | V |
|---|---|---|---|
| | All Intra HE | | |
| Class A | 0.0% | 0.0% | 0.0% |
| Class B | 0.0% | 0.0% | 0.0% |
| Class C | 0.0% | 0.0% | 0.0% |
| Class D | 0.0% | 0.0% | 0.0% |
| Class E | 0.0% | 0.0% | 0.0% |
| Overall | 0.0% | 0.0% | 0.0% |
| Enc Time[%] | | 100% | |
| Dec Time[%] | | 101% | |
| | Random Access HE | | |
| Class A | 0.0% | 0.0% | 0.0% |
| Class B | 0.0% | 0.0% | 0.0% |
| Class C | 0.0% | 0.0% | 0.0% |
| Class D | 0.0% | 0.0% | 0.0% |
| Class E | 0.0% | 0.0% | 0.0% |
| Overall | 0.0% | 0.0% | 0.0% |
| Enc Time[%] | | 100% | |
| Dec Time[%] | | 99% | |
| | Low delay B HE | | |
| Class A | | | |
| Class B | 0.0% | 0.0% | 0.0% |
| Class C | 0.0% | 0.0% | 0.0% |
| Class D | 0.0% | 0.0% | 0.0% |
| Class E | 0.0% | 0.0% | 0.0% |
| Overall | 0.0% | 0.0% | 0.0% |
| Enc Time[%] | | 100% | |
| Dec Time[%] | | 100% | |

Grouping the bypass bins of the last position coordinates together improves the throughput of the CABAC. Specifically, the unary bins of the last position coordinates are coded together followed by encoding the fixed bins of the last position coordinates. There is no negative impact on coding efficiency.

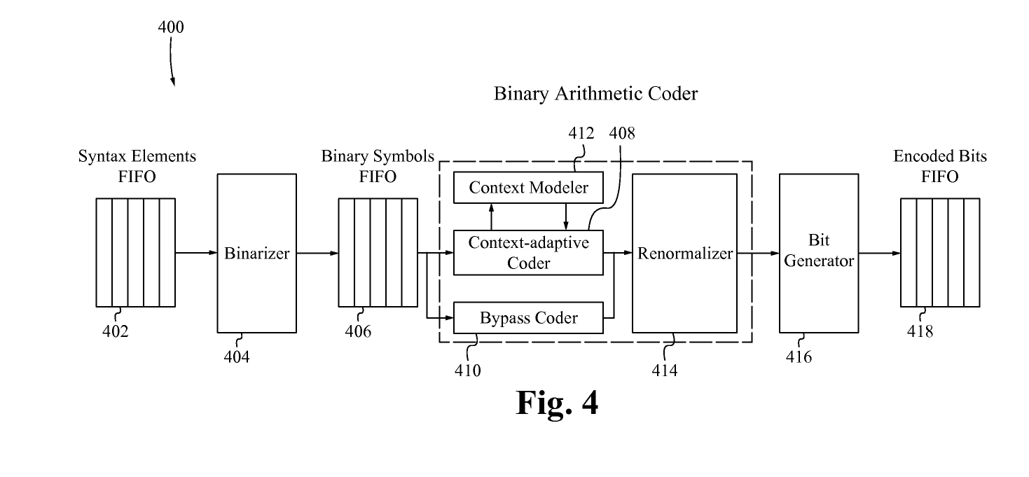

FIG. 3 illustrates a flowchart of a method of CABAC encoding according to some embodiments. In the step 300, binarisation is performed. Binarisation is a pre-processing step that reduces the alphabet size of syntax elements to a reduced binary alphabet. The result is an intermediate binary codeword or bin string for each syntax element. Three types of bins are generated: regular bin, bypass bin and terminate bin. Several binarisation schemes are used in CABAC. In some embodiments, the unary bins of both x and y are encoded first, and then the fixed bins of x and y are encoded later in bypass mode. In the step 302, context-based and bypass binary arithmetic coding is implemented. For regular bin coding, one context model is chosen and fetched from a pre-defined set of context models, and the context model is updated after bin coding based on bin value. Binary arithmetic coding performs arithmetic coding of each bin based on bin value, type and the corresponding context model of the bin. In the step 304, renormalization is applied which rescales the arithmetic coding states. In the step 306, bit generation generates the output bits and appends them to an output stream. In some embodiments, more or fewer steps are implemented. In some embodiments, the order of the steps is modified.

FIG. 4 illustrates a high-level architecture of a CABAC encoder according to some embodiments. The CABAC encoder 400 includes a syntax elements FIFO 402 which sends the syntax elements to the binariser 404 in a first in, first out fashion. From the binariser 404, the binary symbols 406 are output in a FIFO manner. The binary symbols 406 are received by a context-adaptive coder 408 and a bypass coder 410. As described above, in some embodiments, the unary bins of both x and y are encoded first, and then the fixed bins of x and y are encoded later in bypass mode. The context-adaptive coder communicates with a context modeler 412. The context-adaptive coder 408 and bypass coder 410 each send encoded data to a renormalizer 414. The renormalizer 414 then sends the data to a bit generator 416 which generates encoded bits 418 in a FIFO.

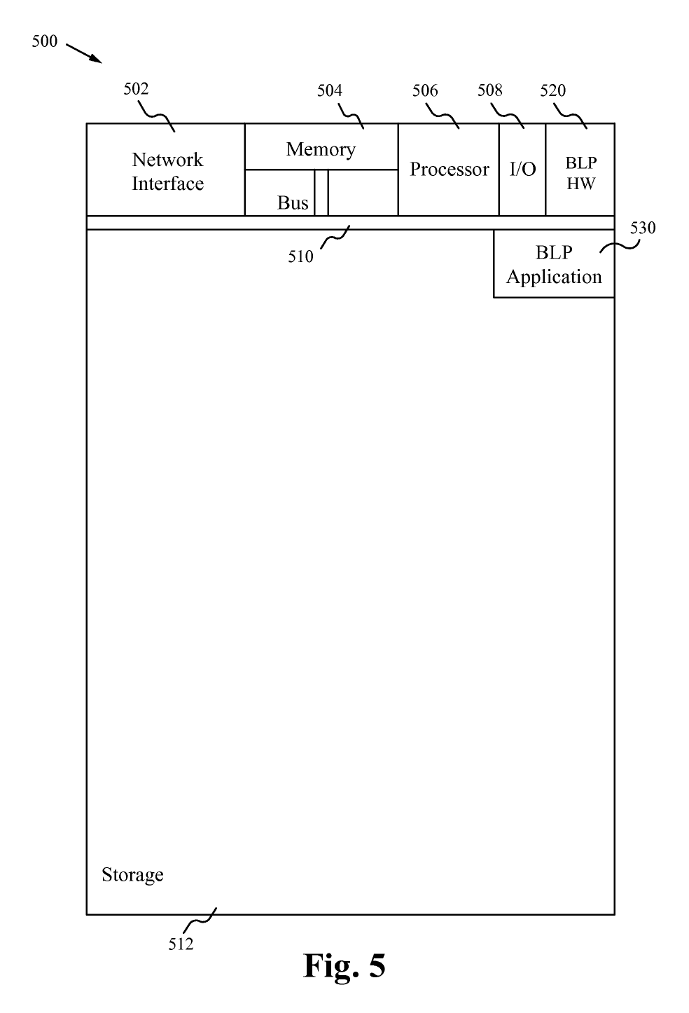

FIG. 5 illustrates a block diagram of an exemplary computing device configured to implement the binarisation of last position method according to some embodiments. The computing device 500 is able to be used to acquire, store, compute, process, communicate and/or display information such as images, videos and audio. For example, a computing device 500 is able to be used to acquire and store a video. The binarisation of last position method is typically used during or after acquiring a video. In general, a hardware structure suitable for implementing the computing device 500 includes a network interface 502, a memory 504, a processor 506, I/O device(s) 508, a bus 510 and a storage device 512. The choice of processor is not critical as long as a suitable processor with sufficient speed is chosen. The memory 504 is able to be any conventional computer memory known in the art. The storage device 512 is able to include a hard drive, CDROM, CDRW, DVD, DVDRW, Blu-Ray®, flash memory card or any other storage device. The computing device 500 is able to include one or more network interfaces 502. An example of a network interface includes a network card connected to an Ethernet or other type of LAN. The I/O device(s) 508 are able to include one or more of the following: keyboard, mouse, monitor, display, printer, modem, touchscreen, button interface and other devices. In some embodiments, the hardware structure includes multiple processors and other hardware to perform parallel processing. Binarisation of last position application(s) 530 used to perform binarisation of last position method are likely to be stored in the storage device 512 and memory 504 and processed as applications are typically processed. More or fewer components shown in FIG. 5 are able to be included in the computing device 500. In some embodiments, binarisation of last position hardware 520 is included. Although the computing device 500 in FIG. 5 includes applications 530 and hardware 520 for implementing the binarisation of last position method, the binarisation of last position method is able to be implemented on a computing device in hardware, firmware, software or any combination thereof. For example, in some embodiments, the binarisation of last position applications 530 are programmed in a memory and executed using a processor. In another example, in some embodiments, the binarisation of last position hardware 520 is programmed hardware logic including gates specifically designed to implement the method.

In some embodiments, the binarisation of last position application(s) 530 include several applications and/or modules. In some embodiments, modules include one or more sub-modules as well.

Examples of suitable computing devices include a personal computer, a laptop computer, a computer workstation, a server, a mainframe computer, a handheld computer, a personal digital assistant, a cellular/mobile telephone (e.g. an iPhone®), a smart appliance, a gaming console, a digital camera, a digital camcorder, a camera phone, a portable music device (e.g. an iPod®), a tablet computer (e.g. an iPad®), a video player, a DVD writer/player, a Blu-ray® writer/player, a television, a home entertainment system or any other suitable computing device.

To utilize the binarisation of last position method, a device such as a digital camera is able to be used to acquire a video or image. The binarisation of last position method is automatically used for performing image/video processing. The binarisation of last position method is able to be implemented automatically without user involvement.

In operation, the binarisation of last position method enables faster processing of information and reducing storage space requirements. Potential applications of this implementation include use with the HEVC codec.

### SOME EMBODIMENTS OF BINARISATION OF LAST POSITION FOR HIGHER THROUGHPUT

1. A method of implementing a context-adaptive binary arithmetic coding of a coordinate (x, y) programmed in a device comprising:
   a. performing binarisation;
   b. implementing context-based and bypass binary arithmetic coding, wherein unary bins of x and y are encoded before fixed bins of x and y are encoded; and
   c. generating output bits from the context-based and bypass binary arithmetic coding.
2. The method of clause 1 further comprising applying renormalization.
3. The method of clause 1 wherein a truncated unary coding part of a first component is encoded before a truncated unary coding part of a second component.
4. The method of clause 1 wherein a truncated unary coding part of a second component is encoded before a truncated unary coding part of a first component.
5. The method of clause 1 wherein a fixed coding part of a first component is encoded before a fixed coding part of a second component.
6. The method of clause 1 wherein a fixed coding part of a second component is encoded before a fixed coding part of a first component.
7. The method of clause 1 wherein the fixed bins of x and y are encoded in a bypass mode.
8. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.
9. An apparatus for encoding a coordinate (x, y) comprising:
   a. a non-transitory memory for storing an application, the application for:
      i. performing binarisation;
      ii. implementing context-based and bypass binary arithmetic coding, wherein unary bins of x and y are encoded before fixed bins of x and y are encoded; and
      iii. generating output bits from the context-based and bypass binary arithmetic coding; and
   b. a processing component coupled to the memory, the processing component configured for processing the application.
10. The apparatus of clause 9 wherein the application is further for applying renormalization.
11. The apparatus of clause 9 wherein a truncated unary coding part of a first component is encoded before a truncated unary coding part of a second component.
12. The apparatus of clause 9 wherein a truncated unary coding part of a second component is encoded before a truncated unary coding part of a first component.
13. The apparatus of clause 9 wherein a fixed coding part of a first component is encoded before a fixed coding part of a second component.
14. The apparatus of clause 9 wherein a fixed coding part of a second component is encoded before a fixed coding part of a first component.
15. The apparatus of clause 9 wherein the fixed bins of x and y are encoded in a bypass mode.
16. The apparatus of clause 9 wherein the apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.
17. An encoder of a coordinate (x, y) comprising:
   a. a binariser for reducing syntax elements to a reduced binary alphabet;
   b. a context-adaptive coder and a bypass coder for performing encoding including arithmetic coding, wherein unary bins of x and y are encoded before fixed bins of x and y are encoded;
   c. a renormalizer for rescaling arithmetic coding states from the arithmetic coding; and
   d. a bit generator for generating bits and appending the bits to an output stream.
18. The encoder of clause 17 wherein a truncated unary coding part of a first component is encoded before a truncated unary coding part of a second component.
19. The encoder of clause 17 wherein a truncated unary coding part of a second component is encoded before a truncated unary coding part of a first component.
20. The encoder of clause 17 wherein a fixed coding part of a first component is encoded before a fixed coding part of a second component.
21. The encoder of clause 17 wherein a fixed coding part of a second component is encoded before a fixed coding part of a first component.
22. The encoder of clause 17 wherein the fixed bins of x and y are encoded in a bypass mode.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of implementing a context-adaptive binary arithmetic coding of a coordinate (x, y) programmed in a device comprising:
a. performing binarisation;
b. implementing context-based and bypass binary arithmetic coding, wherein unary bins of x and y are encoded before fixed bins of x and y are encoded; and
c. generating output bits from the context-based and bypass binary arithmetic coding.

2. The method of claim 1 further comprising applying renormalization.

3. The method of claim 1 wherein a truncated unary coding part of a first component is encoded before a truncated unary coding part of a second component.

4. The method of claim 1 wherein a truncated unary coding part of a second component is encoded before a truncated unary coding part of a first component.

5. The method of claim 1 wherein a fixed coding part of a first component is encoded before a fixed coding part of a second component.

6. The method of claim 1 wherein a fixed coding part of a second component is encoded before a fixed coding part of a first component.

7. The method of claim 1 wherein the fixed bins of x and y are encoded in a bypass mode.

8. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.

9. An apparatus for encoding a coordinate (x, y) comprising:
a. a non-transitory memory for storing an application, the application for:
i. performing binarisation;
ii. implementing context-based and bypass binary arithmetic coding, wherein unary bins of x and y are encoded before fixed bins of x and y are encoded; and
iii. generating output bits from the context-based and bypass binary arithmetic coding; and
b. a processing component coupled to the memory, the processing component configured for processing the application.

10. The apparatus of claim 9 wherein the application is further for applying renormalization.

11. The apparatus of claim 9 wherein a truncated unary coding part of a first component is encoded before a truncated unary coding part of a second component.

12. The apparatus of claim 9 wherein a truncated unary coding part of a second component is encoded before a truncated unary coding part of a first component.

13. The apparatus of claim 9 wherein a fixed coding part of a first component is encoded before a fixed coding part of a second component.

14. The apparatus of claim 9 wherein a fixed coding part of a second component is encoded before a fixed coding part of a first component.

15. The apparatus of claim 9 wherein the fixed bins of x and y are encoded in a bypass mode.

16. The apparatus of claim 9 wherein the apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an portable music player, a tablet computer, a video player, a DVD writer/player, a Blu-ray writer/player, a television and a home entertainment system.

17. An encoder of a coordinate (x, y) comprising:
a. a binariser for reducing syntax elements to a reduced binary alphabet;
b. a context-adaptive coder and a bypass coder for performing encoding including arithmetic coding, wherein unary bins of x and y are encoded before fixed bins of x and y are encoded;
c. a renormalizer for rescaling arithmetic coding states from the arithmetic coding; and
d. a bit generator for generating bits and appending the bits to an output stream.

18. The encoder of claim 17 wherein a truncated unary coding part of a first component is encoded before a truncated unary coding part of a second component.

19. The encoder of claim 17 wherein a truncated unary coding part of a second component is encoded before a truncated unary coding part of a first component.

20. The encoder of claim 17 wherein a fixed coding part of a first component is encoded before a fixed coding part of a second component.

21. The encoder of claim 17 wherein a fixed coding part of a second component is encoded before a fixed coding part of a first component.

22. The encoder of claim 17 wherein the fixed bins of x and y are encoded in a bypass mode.
